(19) United States
(12) Patent Application Publication
(10) Pub. No.: US 2022/0006295 A1
(43) Pub. Date: Jan. 6, 2022

(54) A Method And System For Ageing-Aware Management Of The Charging And Discharging Of Li-Ions Batteries

(71) Applicant: Aurora's Grid Sàrl, Lausanne (CH)

(72) Inventor: Dimitri Torregrossa, Chavannes-près-Renens (CH)

(21) Appl. No.: 17/295,479

(22) PCT Filed: Nov. 25, 2019
(86) PCT No.: PCT/IB2019/060118

§ 371 Date: May 20, 2021

(30) Foreign Application Priority Data
Nov. 23, 2018 (IB) PCT/IB2018/059264

(51) Int. Cl. H02J 3/38; H02J 3/32; H02J 7/35; H02J 3/00; H02J 7/00; G05B 19/042

(52) U.S. Cl. CPC H02J 3/38; H02J 3/32; H02J 7/35; H02J 3/003; G05B 2219/2639; H02J 7/0068; G05B 19/042; H02J 2300/26; H02J 3/004

(57) ABSTRACT

A method for increasing a battery life of a rechargeable battery, the method performed on a system having a renewable energy resource, a rechargeable battery, a battery charger for charging the rechargeable battery, and a load, the method comprising the steps of forecasting a power production of the renewable energy resource and a power consumption of the load for a future time period, determining a net power between a value of the forecasted power production and a value of the forecasted power consumption, and charging the rechargeable battery during a given time period, such that a charging power is lower than the determined net power when the determined net power is positive.

### CROSS-REFERENCE TO RELATED APPLICATIONS

The present patent application claims priority to International patent application No. PCT/IB2018/059264 that was filed on Nov. 23, 2018, the entire contents thereof herewith incorporated by reference.

### FIELD OF THE INVENTION

The present invention relates generally to the management of rechargeable storage batteries, and more specifically to battery charger devices, systems, and methods used in conjunction with the management of rechargeable storage batteries.

### BACKGROUND

Battery energy storage, having a storage capacity from a few Wh up to MWh, are finding widespread use in many applications, and will be used even more in the near future. For example, the 2030-2050 Energy strategy of the European Union has set ambitious goals in term of renewable energy penetration and C0₂ emission reduction. Within this context, as depicted in several references, electricity storage will play a crucial role in enabling next phase of the energy transition and in decarbonizing key segments of the energy market. From a worldwide point of view Adnan Z. Amin, General-Director of International Renewable Energy Agency (“IRENA”) declared that the role of energy storage based on electrochemical batteries will be crucial for accelerating the renewable energy deployment. Ralon et al., “Electricity Storage and Renewables: Costs and Markets to 2030,” October 2017, Abu Dhabi, ISBN 978-92-9260-038-9. In fact, due to the falling price of battery energy storage (BES) based on Lithium-ion cells (60% last 5 years), this type of energy storage has been defined as a disruptive technology for the future energy market.

In the incoming years, Li-ions BES can be grouped in three main usage-categories: i) stationary, ii) electric vehicles (EVs) and second-life systems. The first ones are, and they will be more and more, deployed in i) buildings for increasing energy renewable self-consumption and compensating daily volatility of renewable energies and in ii) power grid to provide ancillary services (frequency control, peak shaving, etc.). Batteries in EVs will also be deployed to provide ancillary services to the grid (V2G) or to building (V2B). Second-life batteries, coming from aged EVs, could be deployed with reduced performances for grid and building applications from 2023 (the forecasted date for large amount of aged cells from EVs).

However, Li-ions BES are generally charged at a high rate, with the goal to fully or partially charge the BES as soon as possible, so that the BES is quickly available for further power consumption. For example, when charging a BES with a PV system, usually a maximum power tracker is used to maximize the power from the PV system, and the available generated power is then used to charge the BES at a highest possible speed, limited to a maximal charge voltage and a constant current, or by the constant current and constant voltage method. As a consequence, in the field of battery charging and discharging management, due to the fast charging goals, the battery life of the Li-ions BES will be shortened. As explained in U.S. Pat. No. 5,939,864 and U.S. Patent Publication No. 2005/0156577, both of these patent documents being herewith incorporated by reference in its entirety, Li-ion batteries can require careful charging and discharging, to avoid the shortening of the battery life. While there are some methods available to take into account the battery life of Li-ion batteries whilst being charged, there are no systems currently available that allow for a substantially extension of the battery life, for example by taking into account the cyclic usage of the battery. This is ever so important as the costs for Li-ion batteries are substantial. Therefore, there is a strong need for novel and strongly improved Li-ion battery charging and discharging methods with the goal to extend the battery life.

### SUMMARY

According to a first aspect of the present invention, a method for increasing a battery life of a Li-ion battery is provided. Preferably, the method performed on a system having a renewable energy resource for providing power to the Li-ion battery, and a battery charger for charging the Li-ion battery, the method including the steps of forecasting a power production for a future period, and during a power consumption cycle before the future period, discharging the Li-ion battery based on the power production of the forecasted future period, such that a discharging power is lower than a power that is currently consumed. In addition, the invention also relates to a computer readable medium that has computer instructions recorded thereon, the computer instructions configured to perform the battery management method for reduced ageing of batteries when perform on a data processing device that controls a renewable energy power system.

According to another aspect of the present invention, a renewable energy power system is provided. Preferably, the renewable energy power system includes a battery energy storage system having at least one Li-ion battery, a charging and discharging converter for discharging and charging the battery energy storage system. a power consumer, a renewable energy source to provide electrical power to the power consumer and/or the charging and discharging converter, and a system controller in operative connection to control the charging and discharging converter. Preferably, the system controller configured to forecast a power production and a load consumption for a future period, and during a power consumption cycle before the future period, instruct a discharge or a charge of the battery energy storage system with the charging and discharging converter based on the net power between production and consumption of the forecasted future period, such that a discharging/charging power is lower than a power that is currently consumed by the power consumer or produced by the renewable energy source.

According to a second aspect of the present invention, a method for increasing a battery life of a Li-ion battery of a portable electronic device is provided. Preferably, the method is performed on the portable electronic device having a battery charger for charging the Li-ion battery, the method including the steps of determining a duration of an idle time of the portable electronic device based on historic data of past idle times, and during a next idle time, charging the Li-ion battery at a power rate that approximates a duration of the next idle time.

According to other aspect of the present invention, a method is provided that can be operated on Li-ions battery storage system to provide for an ageing-aware charging and discharging strategy that could reduce the ageing itself up to 40% in comparison with an usage of battery energy storage systems (BES) that do not use any ageing-aware strategy, namely any limitation of Crate during charging and discharging, any limitation on depth of discharge (DoD) and any limitation on average state of charge (SoC). An algorithm has been developed that can be performed as a method on a Li-ions battery storage system, capable to reduce the ageing of the battery, because it is able to reduce the current deployed during charging and discharging phase, the so called C-rate, and the DoD, and average SoC by taking into account meteorological forecast and human behavior associated with the multiple BES usages, for example but not limited to load consumption in building, required energy content in electric vehicles and usage of smartphone. Generally, the C-rate is defined as a measure of the rate at which a battery, for example the BES, is discharged or charged relative to its maximum capacity, as an indication of a nominal charging or discharging rate. It is defined as the current through the battery divided by the theoretical current draw under which the battery would deliver its nominal rated capacity in one hour, and the same applies for battery charging. C-rate is used as a rating on batteries to indicate the maximum current that a battery can safely deliver on a load. For example, a 1 C rate means that the discharge current will discharge the entire battery in 1 hour. For a battery with a capacity of 100 Ah, this equates to a discharge current of 100 Amps. The method can be applied to various types of storage systems, for example but not limited to Li-ion cells that are used for buildings, power grids, electric vehicles such as cars, trucks, and bikes, smartphones and laptops, medical devices.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 shows an exemplary graph showing two curves for power consumption and power production over time of a BES without ageing-aware strategy, connected exemplarily to a photo-voltaic (PV) device;

FIG. 2 shows an exemplary graph showing two curves for power consumption and power production over time of a BES when using an ageing-aware battery charging method, according to one aspect of the present invention; and

FIG. 3 shows an exemplary system according to another aspect of the present invention, for performing the method of ageing-aware charging of the battery system;

FIG. 4 shows another exemplary system according to still another aspect of the present invention, for performing the method of ageing-aware charging of the battery system;

FIG. 5 exemplarily shows two different graphs depicting the PV production forecast and actually generated PV production during a day, starting at 6 am in the morning and ending at 10 pm (22:00) in the evening, for a summer day, more specifically May 31, 2019;

FIG. 6 exemplarily shows graphs of PV production forecast and actually generated PV production for a 24 h day, with different labels along the measured PV production forecast with the pattern classification S for sunny, C for cloudy, and M for mixed of the PV forecast;

FIG. 7 exemplarily shows a graph of the power or load consumption values and the corresponding load forecast over few days with an exemplary sampling time of 5 minutes, from May 24-26, 2019;

FIG. 8 exemplarily shows real-time pattern classification of load forecast at the EMPA facility, from Mar. 21-22, 2019;

FIG. 9 shows an exemplary and schematic flow chart of the method of eco-friendly energy management or reduced battery aging management EMS;

FIG. 10 shows graphs that represent real measurement of capacity losses of Li-ion NMC cell at DoD equal 100% and C-rate equal 1 and 0.25;

FIG. 11 shows graphs of extrapolated mode of capacity losses of Li-ion NMC cell at DoD equal 100% and C-rate equal 1 and 0.25;

FIG. 12 shows graphs of real measurement of capacity losses of Li-ion NMC cell at DoD equal 100% and C-rate equal 1 and 0.25;

FIG. 13 shows graphs of an experimental test where the operation of the EMS method can be seen, on a 100 kWh/100 kW BES test setup of the HEIG-VD test site;

FIG. 14 shows graphs of another experimental test where the operation of the EMS method can be seen, on a 100 kWh/125 kW BES test setup of the EMPA test site;

Table I shows exemplarily shows different C-rate reduction factors based on both the PV energy production class and the energy consumption class, based on the four-step (for PV production) and seven-step (for power consumption) classification scheme; and

Table II exemplarily summarizes the main results in the three targeted BESs of three different test sites HEIA-FR, EMPA, HEIG-VD, and highlights the C-rate reduction in charge and discharge phases.

### BRIEF DESCRIPTION OF THE SEVERAL EMBODIMENTS

According to an aspect of the present invention, the present method and system is used for battery storage systems for building and power grid applications. Different applications and categories of BES can be deployed for increasing energy self-consumption of modern building as well as to provide ancillary services to the grid (frequency control, peak shaving, etc.). As a principle goal of the present method and system, the profitability of BES is increased by minimize its ageing by the use of a charging and discharging strategy with an algorithm.

It is worth noting that ageing of Li-ions BES depends mainly on: i) current deployed for charging and discharging the battery (the so called charge and discharge C-rate), ii) the duration associated with the discharging phase (the so called depth of discharge, DoD), iii) the temperature and iv) the average state of charge. There herein discussed embodiments refer to the power generation by a PV system, and the storage of energy in a BES device that used Li-ion batteries. However, it is also possible that the same principles of the method and system are used for other types of renewable energy resources instead of PV power, or combinations thereof, for example wind power generation, and also other types of rechargeable batteries.

More specifically, if we deploy a charging or a discharging current that is twice a predefined value, we can accelerate the ageing of the BES up to 50%. If we go down to 0% of state of charge with high value of current, the majority of the energy that has been stored into the battery is used, and thereby the ageing of the battery is increased. A cycle at 100% DoD is equivalent of 2.5 cycles at 50%. An increase temperature of eight (8) Celsius degrees accelerates the ageing of a factor two (2). Keeping the battery at state of charge equal to 100% for one day is equivalent to keep the same battery during three (3) days at 60% state of charge.

Based on the above characteristics of the Li-ion batteries, and their behavior at charging and discharging, it is possible to minimize the ageing of the Li-ion batteries based on a method that employs a specific algorithm. The main concept of the algorithm is the following one: if we know/forecast the energy flow that will be used by the battery, for example for the charging or discharging phase, we can reduce the Crate current (charging or discharging), deploy the battery for a longer time window but with reduce Crate (the energy content will be the same, but the ageing will be reduced since we reduce the current flowing into the cell).

In order to explain the mechanism behind our algorithm for reducing the ageing of the battery we describe an example associated with BES in smart building for increasing energy self-consumption from PV plant. In a variant, other types of renewable energy power plants or units can be used instead or in combination with the PV plant, to charge the BES within the context of this method, especially if their production depends on the weather forecast, including but not limited to predictions of rainfall, temperature, solar radiation, waves, wind, cloud coverage, and/or tides, for example but not limited to windmills, geothermal energy systems, hydroelectric power systems, tidal power systems, wave power systems, fuel cells.

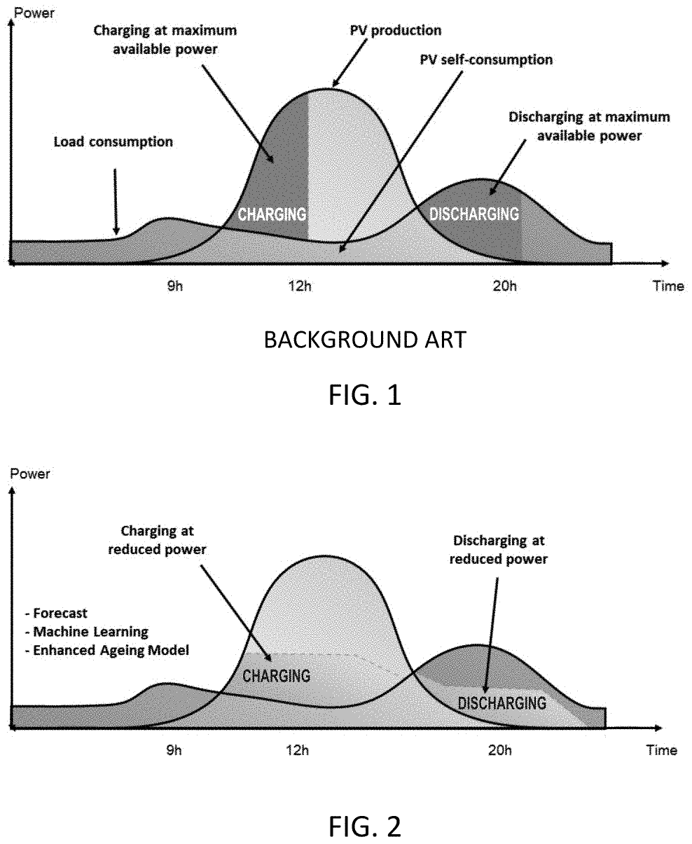

FIG. 1 illustrates an exemplary time evolution of the load consumption and the PV power production of a building equipped with a rooftop PV plant. During the PV production phase a part of this energy that is directly self-consumed by the building and the remaining part is stored into the BES, and used as the charging power. Then, later on, during the evening the PV production is rapidly decreasing in the evening and then nightfall, and the consumption is growing as the residents are back from work, which is typical for a residential building. The battery is discharged in order to self-consuming the PV energy previously stored in the morning. As shown in FIG. 1, the charging and discharging phase is done without any limits or constraints on the deployed current/power, which is a typical for the currently used background art residential and other building-installed PV and BES systems. This results in a fast ageing of the Li-ion batteries of the BES. On the other hand, if we have some information about the future of the PV production, for example the PV production that can be predicted based on the meteorological forecast, and some information of the future of the load consumption, for example a prediction of the human behavior and behavior of automated consumers, it is possible to optimize the charging of the BES to increase the battery life.

For example, the following criteria can be respected to pursue such a goal:

(i) during a time window in which there is a surplus of PV production relative to the energy consumption, it is possible to charge the battery slower that what would be possible, namely with reduced current but for a longer duration;

(ii) during a time window for which there is no PV production or very little PV production below a certain threshold, and it is known that the load consumption will be kept for longer time, it is possible to discharge the battery slower, namely with lower current but for longer duration.

By observing the two last approaches for charging and discharging the battery it is possible to assume that the ageing of the batteries of a BES can be reduced by accounting for meteorological and human behavior forecast. The algorithm takes the decision or the optimal current and DoD to be deployed for the next 15 minutes, for the next hour, or for the next several hours. Based on the measurement of PV production and load consumption at Time To, the algorithm forecasts a difference D between PV and Load at different time horizon in the future, for example a forecast for a period T that will happen in a future timeframe FT, in duration of minutes, tens of minute hours, etc. Based on this forecasted difference D, the algorithm calculates the minimum current and DoD to be deployed for minimizing the ageing of the battery. At each sample measurement time the forecast is corrected and consequently also the current and DoD profile. The algorithm keeps the memory of past usage of the battery, in this case it is possible to compensate possible over-usage or under-usage of the battery itself. Moreover, the algorithm can be based on a machine learning approach that relies on a correlation matrix linking the measured value with the forecasted value at different time steps. Based on this difference, an optimization problem is solved in order to calculate the best of a potential charging/discharging profile. The objective is to reduce the ageing while keeping a good benefit, namely not reducing too much the value of charging or discharging energy. In this respect, the algorithm can limit the power, but the energy may not be limited. A trivial way to reduce ageing is just limiting the C-rate of the charging current for the BES, thereby never always using relatively small charging currently, but such method has the disadvantages of not able to fully charge the BES, or not being able to self-consuming all the stored energy with associated loss on economic profitability. Consequently, the BES capacity and/or the PV production capability would have to be much larger, and may not lead to an economically viable solutions.

The algorithm is configured to, after a training period and/or adaptive normalization of the values, to i) classify the type of day or moment in a day, by detecting sunny day, cloudy day and partial cloudy day. In this way the algorithm can predicts if the PV production will be high or not, for example a very high for sunny day. If during a day there is a moment of several minutes with cloud passing, temporarily there will be loss of PV production, and the algorithm detects consequently the cloud passing and it will not mitigate the current to be deployed for charging the current. On the other hands, if it understands that there is sunny day it knows that it can take the risk to mitigate the charging power of the battery with very low risk to not being able to charge completely the battery. With the same approach it is able to understand and detect behavior of energy consumption and consequently limiting the discharging power of the battery. As an example, a weather and consumption forecast method and system using machine learning can be used as described in U.S. Patent Publication Nos. 2015/0317589 and 2012/0240072A1 can be used, these references herewith incorporated by reference in their entirety.

FIG. 2 shows the usage of BES with our ageing-aware strategy as discussed above, implementing and pursuing criteria (i) and (ii), where the meteorological condition/forecast and real usage from the final user are observed and taken into account. For example, the forecast of the meteorological condition can be done by one or more local sensors, for example an irradiance sensor or high-resolution sky camera. Moreover, to perform the load measurement of the consumer and the power generation of the PV system, it is possible to use a current and voltage sensor that may already be available. We do not need any PV model to feed our algorithm, just power production and consumption.

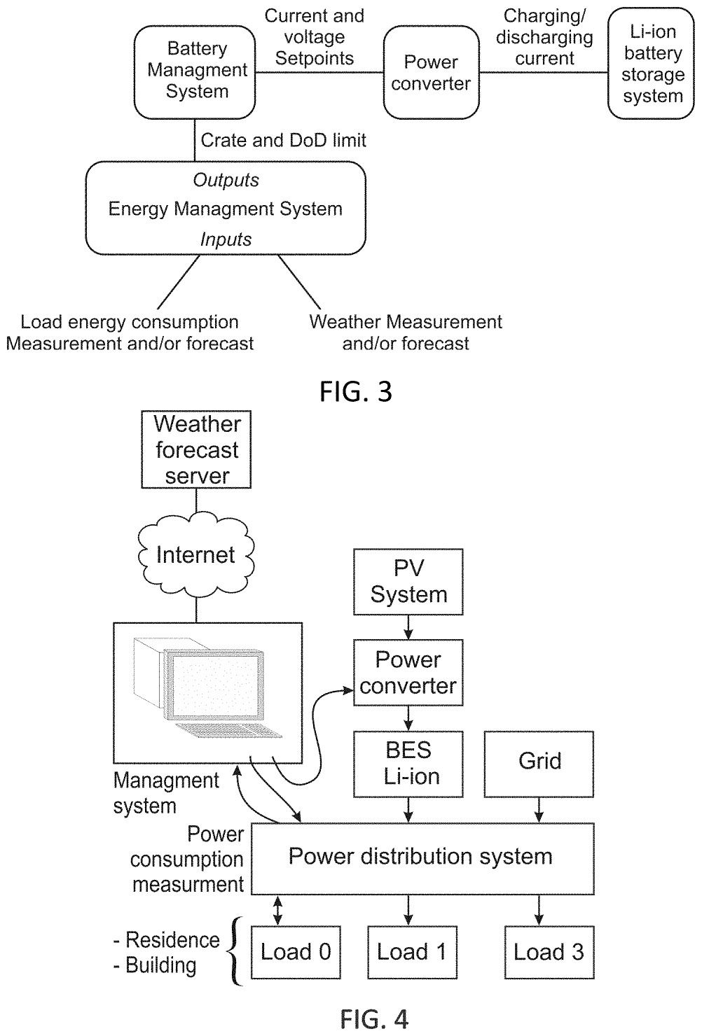

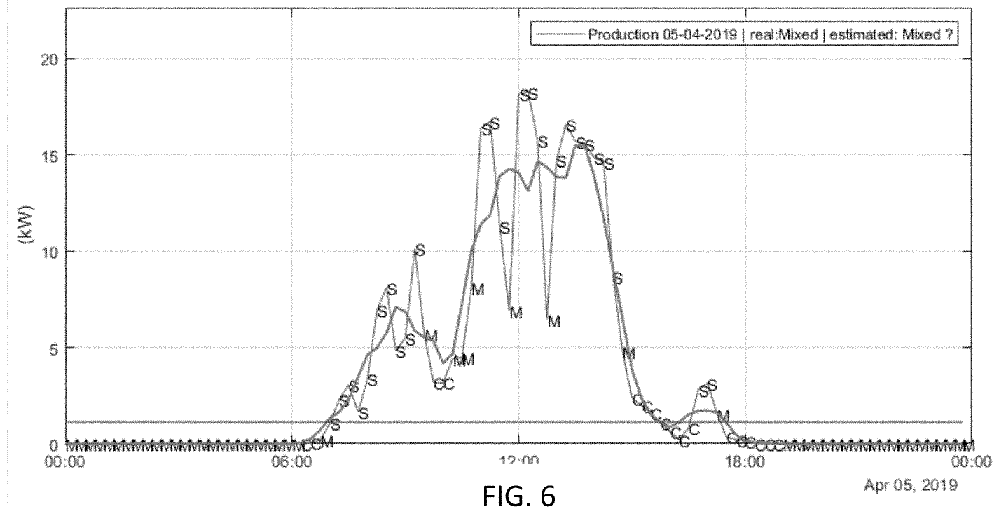

FIG. 3 illustrates, schematically how our energy management software is interfaced with existing infrastructure, namely battery management system (BMS), power converter and Li-ions battery itself. For this purpose, for example, a system as shown in FIG. 6 of U.S. Patent Publication Number No. 2010/0017045 could be used, in which the home energy management system has access to the internet to access weather forecast data, or makes his own weather forecast based on local or remote sensors, this reference being herewith incorporated by reference in its entirety.

FIG. 4 shows an exemplary system for implementing the method. The method can be performed on the management system that can include on or more computers, configured to control the power converter or battery charger for charging the BES by the PV system, and configured to control the power distribution system to control the discharging of the BES, for example via the same or another power converter. Also, the management system includes a data communication port to access the internet, so that weather forecast data can be accessed via a third party provider data server. Also, it is possible that the management system calculates a weather forecast based on one or more local sensors, for example a barometer or pressure sensor or power sensor, and measurement of the environmental humidity. The forecasting can be based on historic weather data patterns that can be locally stored or remotely accessed via the internet, or otherwise since installation of the software is able to create is historic database. It is not necessary that we save or otherwise record a time evolution of PV production and load consumption, but it is possible to correlate measurement at different time samples in order to extract their dynamics.

It is worth noting that the battery is charged/discharged thanks to a power converter. The power converter receives voltage and current set-points from the battery management system and normally these set points allows for performing the fastest charging or discharging, consequently the highest possible current deployed with the battery and consequently the fastest ageing of the battery itself.

With the herein presented energy management method and system, based on the proposed algorithm we developed and we tested in an simulated environment, it limits the maximum value of current (in charging and discharging) and the duration of this phase (via the DoD). In order to rightly compute the limitation of the current and the DoD it needs to receive the measurement or the prediction/forecast of the energy that will be used by the owner of the battery in the next timescale (seconds, minute or hours) The energy management software can be provided as computer-readable instructions, that can perform the method when executed on one or more computers of the management system. Moreover, for some specific application it needs also to receive measurement or forecast of weather conditions in order to predict/compute the available PV energy, for example by using meteorological forecast data from third party providers, such as but not limited to weather.com, accuweather.com, weather channel, by using the application program interface (API), or by making an own, local weather forecast. Based on these two inputs our algorithm computes the optimal value of current and DoD and it send this information to the BMS that will take care of charging and discharging the battery via the power converter. The algorithm is implemented as a method in that is performed by the energy management system, as exemplarily shown in FIGS. 3 and 4. FIG. 3 shows a block diagram of Li-ion battery coupled with power converter, BMS and an energy management system.

For available home-energy storage the Crate that the power converter can deliver or extract from the battery is limited by the performances/cost of the power converter. As example, battery storage system from 2-3 kWh up to 15-20 kWh often they have a bidirectional power converter of 60-80% the 1 C-rate power, namely 60-80% of the nominal capacity of the battery. Our algorithm is limiting more the value of this C-rate power, from 60-80% down to 25-40%. For this reason is able to reduce the ageing of the li-ion battery.

Next, according to another aspect of the present invention, a battery storage system can be provided for charging a smartphone and a laptop, or another type of portable electronic device. In this application, the SOC is limited during a long rest-phase of the portable device, for example but not limited to a tablet, smartphone, music/video player, and the charging of the battery is performed just few hours before the user need it.

Another example that could be deployed for explaining the importance of our algorithm, concerns the battery placed in smart-phone. We know that the majority of people leave the smartphone charging during the night before going to the bed. Actually the charging phase is not limited in current, but since our software is able to learn the behaviors of people using any device, it is possible to slowly charge the battery of the smartphone during 4-5 hours, instead of charging it in one hour with high current) without impacting the comfort of the final user, since in the morning when he wakes up the smartphone will be charged at 100%. Once again, our software interfaces/communicates with the BMS installed into the smartphone in order to change the voltage and current setpoints of the power converter that will be deployed to charge the battery itself.

According to another aspect of the present invention, a model-free and sensor-free method and system for forecasting the photovoltaic (“PV”) production and forecasting the load consumption production is provided. Generally, the totality of the PV and load forecast techniques may require (i) either complicated PV or load model, (ii) either expensive sensor system, for example a high resolution sky-camera or irradiance sensor with associated installation cost and maintenance of these sensors and (iii) access to weather forecast data. In this respect, according to an aspect of the present embodiment, the goal of operating the system with a BES operatively coupled with a building, facility, residence, plant, premises, compound (references herein as R) that is equipped with PV is not to forecast the PV production or the load consumption with an accuracy of 99% or more. Instead, it is desired to have an indication, preferably with an accuracy of about 85%-95%, of both PV and load consumption value, evaluate their time difference and compensate such difference, either a positive or negative difference, with the battery energy capacity of the BES. In this respect, the BES can absorb energy from the PV or inject energy to the building R. From this stand-point, a method and system has been developed that uses PV and load forecast capable to predict those values with an accuracy of 80-90% without any sensor and any PV model. This technique and approach is part of the proposed system and method, also called eco-friendly energy management system (EMS) having a goal to mitigate the charging and discharging power of the BES and consequently the reduction of the ageing of the BES.

The algorithm used in the system and method is based on a pattern classification machine learning approach. The algorithm follows to goal of predicting or forecasting the production of PV power production value, to determine an absolute and relative value, in a future time window, and the PV power production value depends predominantly on the solar radiance. It has been found that the PV power production value is strongly correlated with the last measured points or values of solar radiation, rather than the historical production data, with the most recent measurement point an value having the largest weight, during a relatively short time window, of preferably maximally 15 minutes. In a variant, the prediction time window can be less than 3 hours, less than 1 hour, or less than 30 minutes, depending on the volatility or variability of the power production of the renewable energy resource, in the present case being PV. This can also depend on a location where the system is deployed, and the weather, wind, temperature or other patterns that are responsible for the power generation. In most cases, the prediction time window smaller than a fraction of day period. Moreover, because the variation in solar radiance is generally gradual, the change in PV power production value over short time windows, for example in a range of 30 sec to 15 min, can be assumed to be linear, and consequently can be calculated with high accuracy using a linear combination of the last measurement points or values of solar radiation. The below equation is used to predict the PV power production value, with the element t for a specific time instant:

prod(t+1)=prod(t)+Δₜ*trend

where trend=(prod(t−1)+prod(t))/2 and Δₜ=(t+1)−t (=1 with normalized sampling rate). Using this formula, the result for the PV power prediction accuracy is generally >99% in average in a variety of different test scenarios tests for a predicted time value at 30 s, it becomes around 90% for 5 minutes to 15 minutes of ahead prediction.

Next, the PV power forecast production is classified into one of three (3) weather classes: Sunny, cloudy, or mixed. Consequently, the forecast of the PV power production value can also provide for a relative indication of the PV power production as compared to the maximum possible value that could have been reached during a sunny day. These values can be pre-stored for all the days of the year, and also can be pre-stored for different time periods of a specific day, given the different levels of maximal solar radiation during a given day. This correlation between the maximum PV production during a specific day of the year and the real-time measurement is performed for each time sample. This correlation is used by the herein presented system or method to reduce the C-rate applied to the BES, being a measure of the rate at which the BES is discharged relative to its maximum capacity. Preliminary to the measurement, it is determined what the range value of potential PV production value can be in order to be classified in one of the three (3) above-defined sub-classes. The number three of subclasses is only exemplary, and it would be possible to use a different number of subclasses, for example more than three.

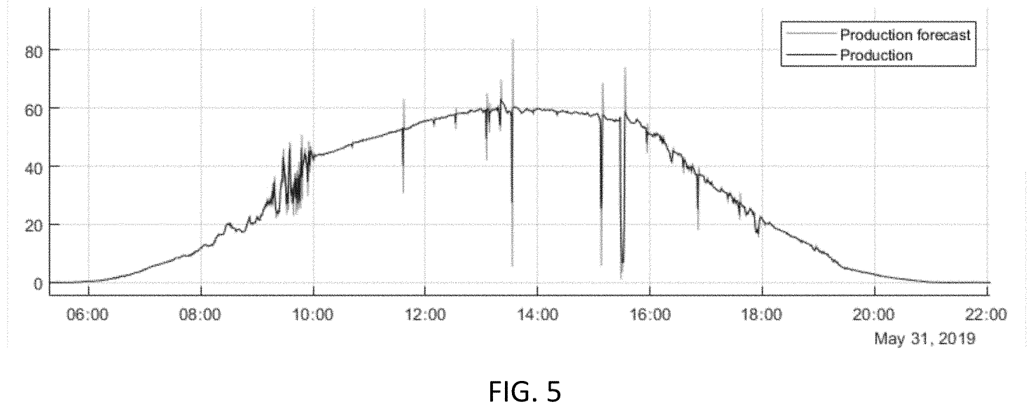

As an example, FIG. 5 shows two different graphs showing the PV production forecast and actually generated PV production during a day, starting at 6 am in the morning and ending at 10 pm (22:00) in the evening, for a summer day, more specifically May 31, 2019. These tests were done at a so-called Smart-Building at EMPA (“Swiss Federal Laboratories for Materials Science and Technology,” or “Eidgenössische Materialprüfungs- and Forschungsanstalt”) Institute in the Canton of Zurich in Switzerland. At this site, a Leclanché 100 kWh/100 kW NMC-G Battery as a BES is operatively coupled with a 80 kW PV peak power photovoltaic system. This BES coupled with PV is connected to a living lab environment prosuming energy for currently twenty (20 people in residential, office, leisure and mobility sector. The system infrastructure can be accessed remotely enabling data readouts of historical data and/or controllability of the mentioned components. The generated PV production are based on real-time measurements from the PV system with a sampling time of 5 minutes (12 measurements per hour). Moreover, as another example, FIG. 6 shows graphs of PV production forecast and actually generated PV production during a 24h day, with different labels along the measured PV production forecast with the pattern classification S for sunny, C for cloudy, and M for mixed of the PV forecast, for the facility located at EMPA. FIG. 6 shows that even if the absolute value of the PV power has not been forecasted accurately during the high dynamics, the pattern classification has nevertheless been accurately forecasted.

Next, the algorithm also determines the consumption forecast. By following the same methodology developed for the PV forecast the same pattern classification technique can be used for the load consumption. The goal of the load forecast is to predict the load consumption value in the next time window, by taking into account historical or past consumption data. This value is then classified into one of these seven (7) different classes of power consumption: “Very low,” “Low,” “Average low,” “Average,” “Average high,” “High,” “‘Very high.” For the forecasting or predicting the consumption, an higher number of classes (seven) is chosen as compared to the PV pattern classification for the power generation (three), because the variability or variance of the load value, incorporating the unpredictability of human behaviors, was higher as compared to the variance of the PV generation. The number seven is also exemplary, and a different number of classification values could be used.

To predict the next consumption value, a combination of historical statistics is used, in addition to the recent measured values, as expressed in the below equations:

consumption(t+1)=α*consumption(t)+β*consumption(t−1)+γ*historical_consumption−δ*previous_error

where α=0.25, β=0.25, γ=0.5, δ=0.5

previous_error=previous_forecasted_cons−real_cons_value

The determination of the value for “historical_consumption” is based on the historical consumption data over a previous period, for example the last 14 days, and week days and week-ends are differentiated. The differentiation of the weekdays can be based on consumption data that has been gathered from similar buildings, for example whether mostly residential or commercial, and such pre-existing power consumption patterns, but also on a learning approach without any prior knowledge of the power consumption. For example, the method can start to record data from the first moment of power usage to generate a power consumption profile. After a given time period, for example 14 days, the method can detect a power consumption pattern of a typical day, and a portion in the day where the energy consumption could be defined high, medium or low. If after 14 days behavior of the targeted building/grid change, the adaptive method can be operated on a 14 days sliding time window, so new behavior will be accounted for, as discussed below with step S40.

Moreover, each day is split into a certain number of time splices or periods, for example eight (8) time slices or periods where each slice or period has a time duration of three (3) hours. Sliding time windows are used for providing for a moving averaging time frame. The consumption values are averaged over each time slice and the result is stored as “historical_consumption” data and used in the above formula, for example to local or remotely accessible memory of the system.

With the herein presented method and system, the following aspects can be taken into account. First, the system and method allows to take into account the change of power consumption behavior between weekdays and weekends, as it is reflected in the calculations, second, the system and method allows to take into account the change of consumption behaviors between different day times, e.g. morning, afternoon, evening, as this is also reflected in the calculations, third, the system and method allows to take into account. In addition, the system and method allows to take into account changes in consumption over seasons, because the historical data is averaged in a moving window over the last 14 days, and abrupt or discontinuous changes in the power consumption and PV production are directly reflected as well, and the correction factor taking into account the previous error guarantees a convergence towards the correct value.

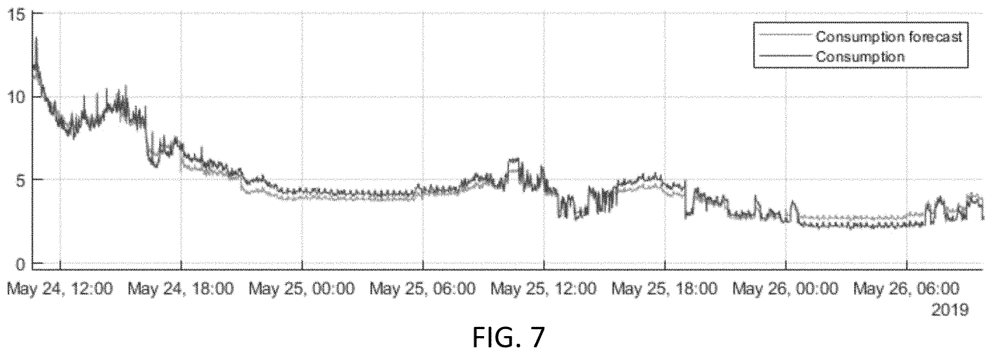

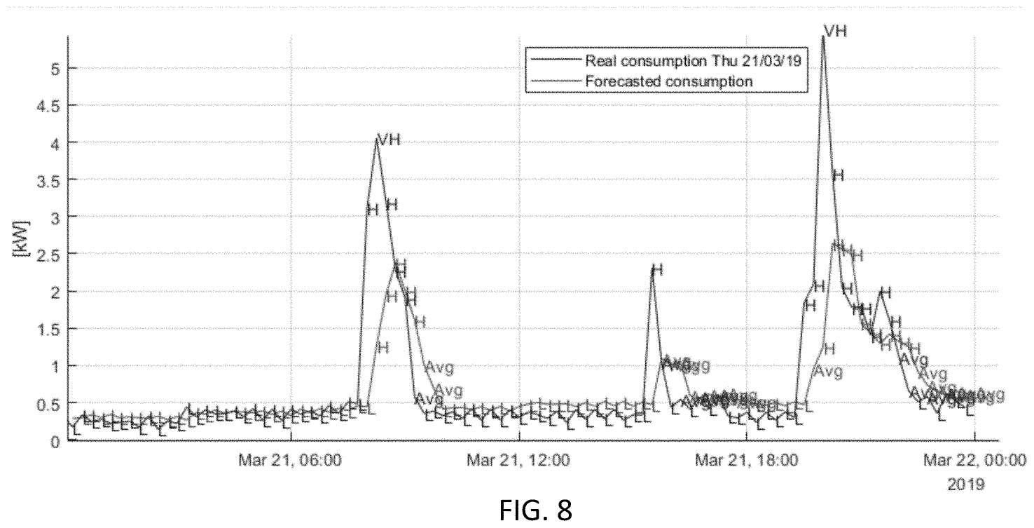

As shown for the PV forecast by the method or system, FIGS. 7 and 8 illustrate an example of pattern classification of the load consumption at the EMPA facility, with FIG. 7 showing a graph of the load consumption values and the corresponding load forecast over few days with an exemplary sampling time of 5 minutes, from May 24-26, 2019, and FIG. 8 showing example of real-time pattern classification of load forecast at the EMPA facility, from March 21-22, 2019.

With respect to the battery ageing-aware energy management method EMS, and corresponding computer code for executing such method with a data processing device that can control, the BES and the PV system, software, a way to illustrate the ageing-aware approach of the developed energy management software for the herein described method and system could be done by making reference to an installation equipped with PV power plant and a BES with a specific size and using a specific battery chemistry. FIG. 1 illustrates the approach followed by the state of the art with their energy management software, namely they are charging and discharging the BES with the maximum available power. FIG. 2 illustrates the approach of the present system and method. Based on our machine learning approach, it is possible forecast the PV production without the need of any expensive high-resolution sky camera and/or real-time solar irradiance sensor, and load consumption and consequently reduce the charging/discharging current, but with longer time duration, and consequently reduce the ageing of the battery. Herein, the operational principle of the ageing-aware algorithm is further explained. All the calculations refer to a simplified scenario or case, namely an energy management deploying always the maximum available power, herein referred to as “available energy management”.

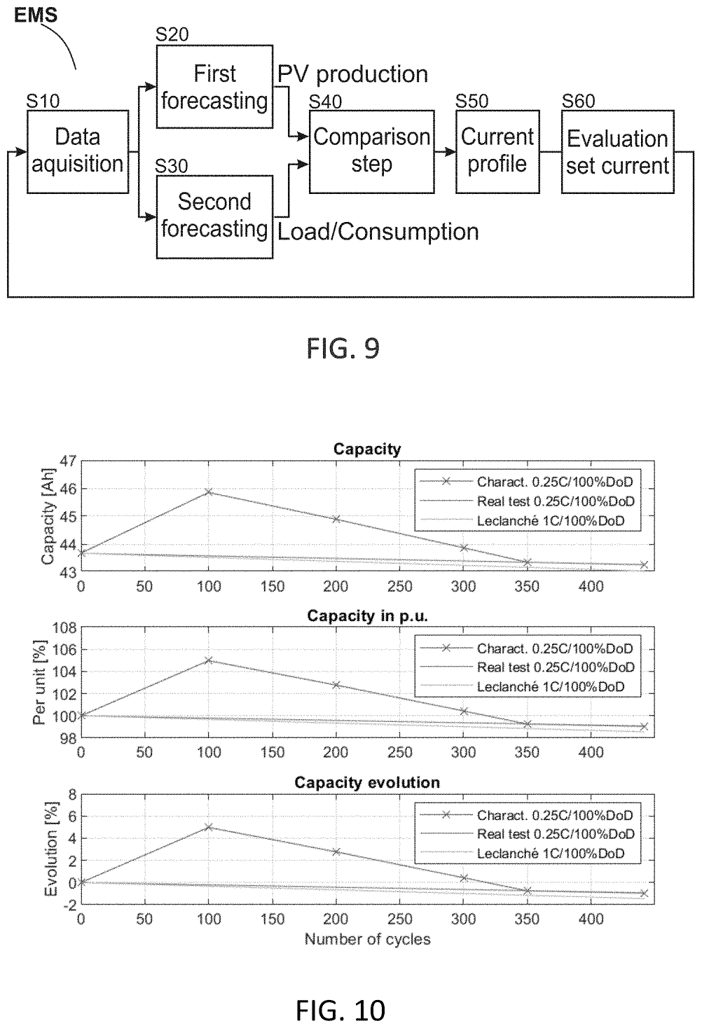

The method of eco-friendly energy management or reduced battery aging management EMS is schematically and exemplarily visualized in FIG. 9, and preferably includes a first data acquisition step S10 where a data processing device, with a non-limiting example a Rasberry PI that is in operative connection with the PV system and BES, acquires the PV generation and the measures the current power consumption load by the use of corresponding sensors, as long as the state of charge (SoC) from the BMS of the targeted battery is provided. Next, a first forecasting step S20 is performed, where the PV forecast algorithm is performed by the data processing device, and computes the forecasted or predicted PV production for the next time step or time period. This time step TS1 for the forecast or prediction is relatively short time view to the future, preferably between 30 seconds to 2 minutes or more. Moreover, a second forecasting step S30 is performed, where the load consumption forecast algorithm by the data processing device is used to forecast or predict the load consumption for the next time step TS2 is determined, preferably between 30 seconds to 2 minutes or more, with TS1 being the same as TS2. The first and second forecasting steps S20, S30 can be performed simultaneously, or in any timely order relative to each other.

Thereafter, the method performs a comparison and classification step S40. In this comparison step, the absolute values of the two above first and second forecasting steps S20, S30 are compared to the PV peak power generation and the peak load consumption for a given time moment for relativization or normalization, and thereafter, the relative or normalized forecasted values are thereafter classified into the different classification patterns, for PV generation and consumption. Specifically, in this step, forecasted PV generation and power consumption are compared with the maximal values of the specific time moment, to determine the ratio between actual value of forecasted PV production and the potential PV generation peak value for a specific moment in time, and between an actual value of power consumption and the potential power consumption peak value, to provide for a normalization of these values relative to the maxima. With the determination of these two ratios, step S40 allows to determine the pattern classification of PV generation, e.g. whether it is S for sunny, C for cloudy, and M for mixed, and whether the power consumption is “very low,” “low,” “average low,” “average,” “average high,” “high,” and “‘very high” referenced to the potential maximal values.

This step can be assisted by a semi-supervised machine learning approach or a signal processing plus clustering method, based on adaptive statistical algorithm, which uses a sliding window having an exemplary two-week duration to adjust the maximal value for both PV generation and consumption maximal values, to predict the future consumption value and classify it into one of seven (7) classes or to predict the future PV generation and classify it into one of three (3) classes. This way, changes in overall consumption can be taken into account, without the need of any active input or changes in the setting values of the system, for example in the case of an apartment building where new tenants have move in or moved out, increasing or reducing the amount of tenants and the consequential increase or decrease of power consumption, or changing the consumption patterns, or if new power-consuming equipment has been added or removed, for example the addition of an elevator. Similarly, for the PV generation, seasonal changes can be taken into account, or long-term seasonal weather pattern shifts, for example the presence of particles and clouds in the air from an active volcano, to take into account changes to the maximal PV generation value, and the subsequent pattern classification. This allows to adjust the maximal values for PV generation and consumption for any given time moment.

Moreover, the comparison and classification step S40 can make the pattern classification of the PV generation (for example three classes) and the power consumption (for example seven classes) based on threshold values that can be predefined, for example based on percentage values relative to the maximal values. These classification values are adhered to the forecasted data for the next step. With step S40, it is possible to normalize the measured values based on maximal values that may be fluctuating substantially over time, without the need of any active system changes. This step can also take into account external weather data from a weather data service provider into account, to adjust the maximal potential PV values.

Based on the comparison step and the differences that have been determined, an optimal constant current profile is determined in step S50, the current being constant for a whole time step, is evaluated, and a charging or discharging instruction is given to the BES via the battery-charging and discharging power converter. This current profile includes a fixed current value for a given time period, and a sign value of the current, i.e. whether the current is used to charge or to discharge the BES. This current profile determines the current to be a BES charging current if the PV production is higher than the load consumption and a BES discharging current if the PV production is lower than the load consumption.

Once the type of current profile, and the determination of the charging or discharging has been established, an evaluation and setting step S60 is performed that will evaluate the value of the constant C-rate of the charging or the discharging to be applied to the BES during the next time sample, and will set the BES charging or discharging current to a reduced value relative to the C-rate when possible, to provide for the ageing-aware charging or discharging by the power converter. This power converter can be a DC-DC converter that allows for charging and discharging the BES, but can also be two separate devices, one for the charging, the other one for the discharging. This step S60 can be done by calculations or by the use of a look-up table, for example with the exemplary look-up table of Table I, where for each pattern classification of PV generation, a factor is given to change the C-rate. Based on the pattern classification of both the predicted power consumption and the pattern classification of the predicted PV generation, a parameter is chosen for the discharging or charging, the parameter being a factor that can reduce the C-rate, as shown in Table I. Statistically speaking, if the value of the predicted PV generation is high, and the value of the predicted power consumption of the load is low, there is no need to charge the battery at full charge current or full C-rate, but instead with a reduced charge current, to avoid battery aging.

The reduction of the C-rate value by a factor below 1 for instruction the power converter to perform a reduced charge or discharge depends on the information associated to the relative value of the predicted PV generation and power consumption. As an example, a PV generation that is classified by step S40 as “sunny” together with a load consumption classified by step S40 as “very low”, step S60 will give a charging current profile with a C-rate very low (namely 0.2 C), because statistically speaking, during the next timestep or time period, in this case a time period of maximal 15 minutes of the sampling rate, this difference between PV and load will also remain high, which will allow for further BES charging at a later time moment. Consequently, it does not make sense, from a BES battery ageing and lifetime point of view, to deploy high value of charging current to charge the battery. Conversely, if the a PV production classify as “sunny” together with a load consumption classified as “very high”, this step S60 will give a charging current profile with a C-rate that is high (namely the nominal or unreduced value 1 C). See for example Table I that shows exemplary values for the C-rate reduction. These values are only exemplary, other values that maintain the basic con cent of age-aware charging and discharging can also be used. In the next sampling period, if the class of PV generation and power consumption is changed, it is possible that the C-rate reduction will also change.

As discussed above with respect to the prediction or forecasting, it is not necessary that the PV production and power consumption is predicted with a very high accuracy. Instead, the forecasting and normalizing with steps S20, S30, and S40 relies on a relative classification of the value of PV generation and power consumption, based on the adaptive maximal values, taking changes to the system into account, to provide the optimal C-rate to be applied to the battery for both charging and discharging of the BES for reducing ageing and not losing any opportunity to charge, in the situation where the PV generation is higher than power consumption, or to provide for an entire discharge of the batteries of the BES, when we need to make self-consumption later on.

At the following sampling period or measurement period, steps S10 to S60 are repeated, to make sure that with every time period, BES battery aging is minimized. With step S60, if the net power between PV system and consumers or load is low, the current profile will not be reduced to reduce the risk to not charge or discharge the BES battery for mitigating the ageing process. The net power or available power is herein defined as a difference between the entire power produced by the PV system and the entire power consumed by the load. The net power is considered positive when there is a surplus in power generation versus power consumption, and is considered negative when there is a less power production than power generation. The ageing process is mitigated only if the available power is considered to be average-high. The method can be encoded as computer instructions that are recorded on a non-transitory computer readable medium, and are configured to perform the method when executed on a data processing device that is in operative control of a PV and BES system.

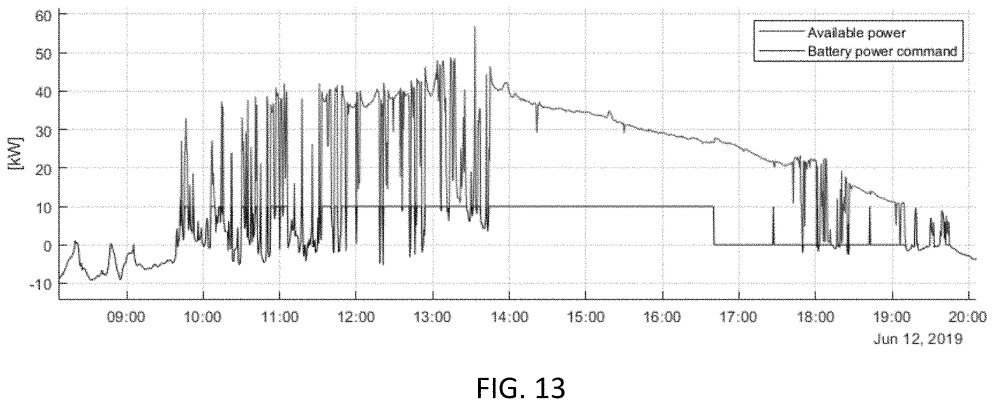

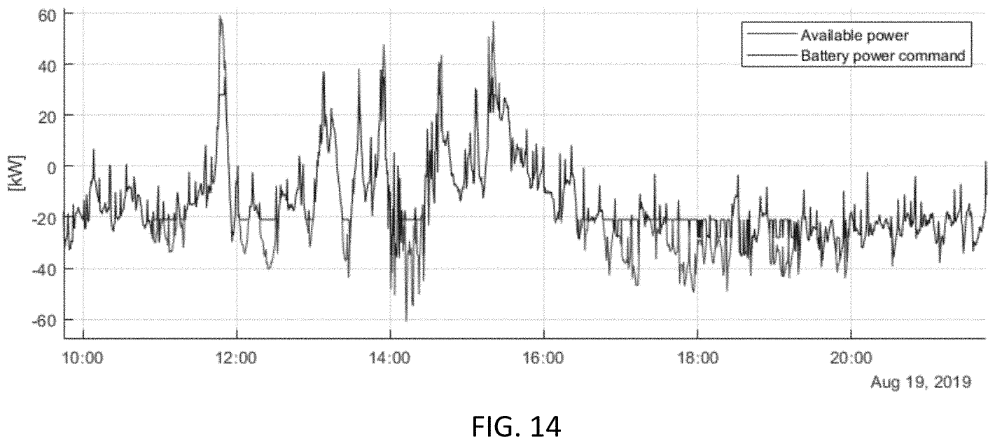

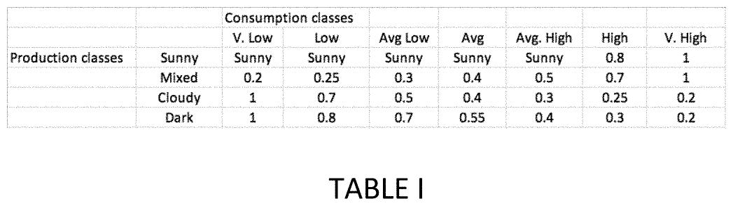

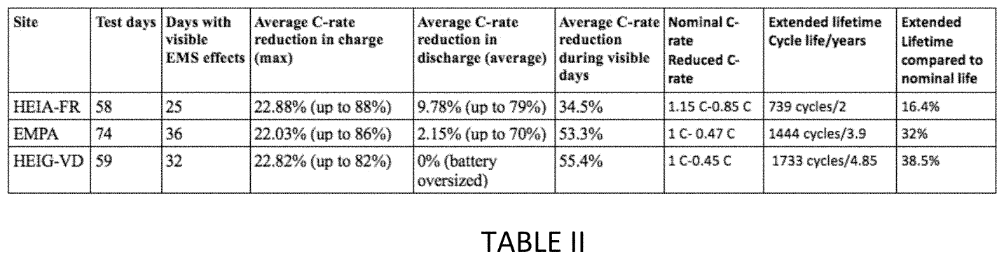

Table II summarizes the main results in the three targeted BESs and it highlights the C-rate reduction in charge and discharge phase for three different test sites HEIA-FR, EMPA, HEIG-VD. The following can be seen from these results. (1) Table I shows the he average C-rate reduction has been calculated only for the ones with visible ageing-reduction effect. (2) Due to the large amount of raining days in the period March 2019 up to June 2019, it has been difficult to obtain a large amount of day for which the solar irradiance was high, consequently the PV production with high value and consequently having the possibility to mitigate the C-rate during the charging phase, see FIG. 1. (3) The overall energy balance is the same whenever we deployed our ageing-aware EMS or an available one. This means that the global charged (energy from PV) and discharged (toward the building) energy into/from the BES are the same (without any economic loss). The effect of current during charging phase is much more important that the one during discharging phase. Consequently, from an electrochemical point of view it is possible to assume the ageing mitigation done by the present system and EMS method is much more important. (4) An ageing stress factor that we have not considered in our ageing computation is the temperature. It is worth noting that overtemperature on Li-ion cells depends on two main factors, equivalent series resistance and current. Reducing the C-rate has a double effect: (i) mitigate the ageing and consequently the increase of the internal resistance and especially (ii) reducing the current. Based on this consideration the targeted BESs have been operated at a lower temperature. In Table I, based on our developed Li-ion ageing model and the dedicated experimental ageing test performed thanks to the Ecobattem project, we tried to “translate” the C-rate reduction into the equivalent ageing mitigation/extended lifetime. FIGS. 13 and 14 show timely evolution of graphs for two different test sites EMPA and HEIG-VD, showing the difference between the available power and the battery power command.

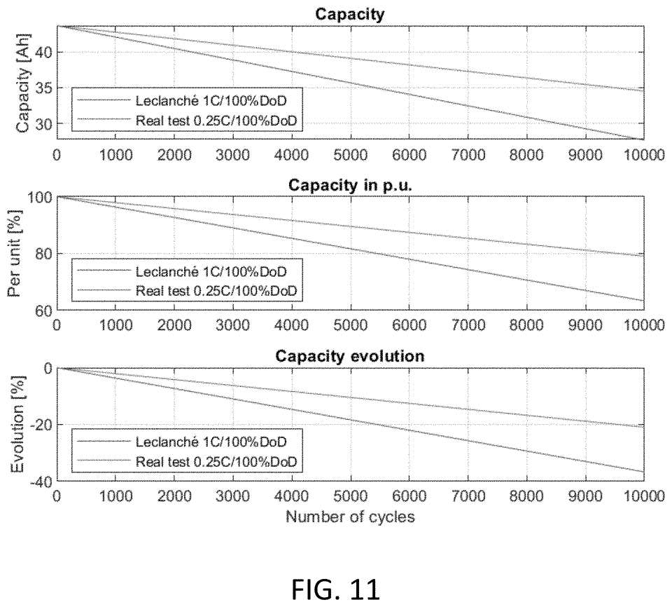

Moreover, in extensive experimental testing, the method and system discussed above have shown good results to reduce battery aging. FIGS. 10 and 11 illustrate the timely evolution of the capacity fading of the targeted Li-ion NMC cell versus the number of cycles during an operating condition characterized by a charging and discharging C-Rate equal to 0.25 C and a DoD equal to 100%. From the experimental test, reducing the C-Rate current has a non-negligible effect on the mitigation of the ageing of the cells. In fact, without anv C-Rate limitation, the battery could deploy the nominal current for cycling the battery itself, for example at a C-Rate equal to 1 and for other application even above. However, the principal goal of the above-discussed method and system to limit the C-Rate where possible preferably at 0.25 C in order to mitigate the capacity fading shows to be successful. Specifically, FIG. 10 illustrates the evolution of capacity fading of Li-ion NMC cell when stressed at 1 C, DoD 100% at 30° C. This capacity fading is based on data sheet given by the manufacturer, illustrates the evolution of real measurement of capacity fading, characterization performed at 0.1 C, of the same cell stressed at 0.25 C DoD 100% at 30° C., and also illustrates the extrapolated model of the capacity fading at 0.25 C, DoD 100%. With FIG. 10, it shows that during the first 350 cycles, due to a known electrochemical phenomenon, the capacity of the targeted cell gets higher than the starting value, then the ageing process starts and it is possible to detect the so-called linear trend, from which we can extrapolate and compare the ageing process with the same type of stress at 1 C, see FIG. 11. The results of FIG. 11 show that after 9800 cycles the cell stressed at 0.25 C lost 20% of the initial capacity, while in order to obtain the same capacity loss at 1 C rate, only 5500 cycles are required. Consequently, at 0.25 C-rate the lifetime is extended of 4300 cycles that means around 86%.

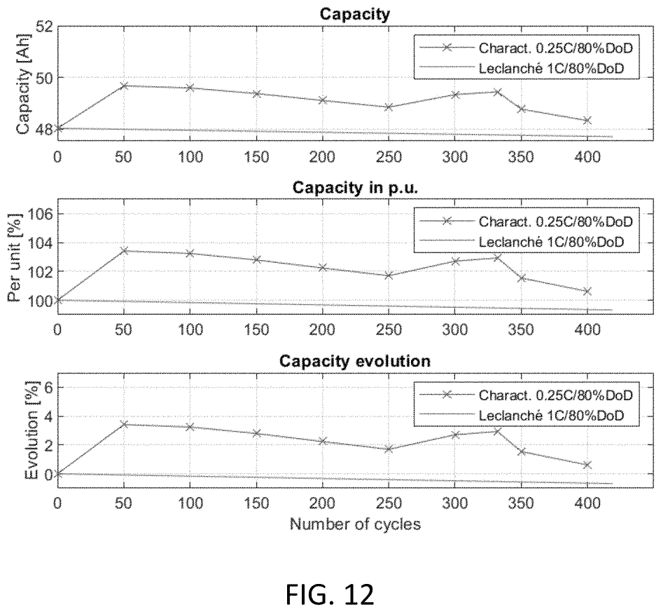

Similarly, FIG. 12 illustrates the time evolution of the capacity fading of the targeted Li-ion NMC cell versus the number of cycles during an operating condition characterized by a charging and discharging C-Rate equal to 0.25 C and a DoD equal to 80%. In the same graph the evolution of capacity fading with 1 C rate at DoD 80% is plotted. By observing FIG. 12, it is possible to show that the capacity of the cell cycled at 0.25 C, after 400 cycles is still higher than its starting value. Consequently, it is not possible to evaluate the so-called linear trend of the capacity fading, and that, what stated above, relies on the following consideration. Normally, decreasing the DoD from 100% down to 80% involves a mitigation of the ageing process of around 60%. Consequently, since at 0.25 C DoD 100% we started to observe capacity fading after 350 cycles, at DoD=80% we should start to observe capacity fading around 560 cycles. With lower C-rate, the internal and surface over temperature of the targeted cell is also lower, and power losses depends on the square current. Consequently, with lower C-rate we obtained an additional advantage that will further mitigate the ageing.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. A method for increasing a battery life of a rechargeable battery, the method performed on a system having a renewable energy resource, a rechargeable battery, a battery charger for charging the rechargeable battery, and a load, the method comprising the steps of:
forecasting a power production of the renewable energy resource and a power consumption of the load for a future time period;
determining a net power between a value of the forecasted power production and a value of the forecasted power consumption; and
charging the rechargeable battery during a given time period, such that a charging power is lower than the determined net power when the determined net power is positive.

2. The method of claim 1, further comprising the step of:
discharging the rechargeable battery during the given time period, such that a discharging power is lower than a power that is currently consumed by the load when the determined net power is negative.

3. The method of claim 1, wherein the charging step, in case the value of the forecasted power production is high as compared to a maximal possible power production, and the value of the forecasted power consumption is low as compared to a maximal possible power generation, the rechargeable battery is charged at a rate that is at least 50% below a c-rate.

4. The method of claim 1, further comprising the step of:
normalizing the predicted power production relative to a maximal power production value, and normalizing the predicted power consumption relative to a maximal power consumption value, wherein in the step of determining, the net power is calculated based on the normalized predicted power production and power consumption values.

5. The method of claim 1, further comprising the step of:
classifying the forecasted power production for the future time period into one of several forecast prediction categories, and classifying the forecasted power consumption of the load into one of several power consumption categories.

6. The method of claim 4, further comprising the step of:
adjusting the maximal power production value and the maximal power consumption value based on a sliding average value in time.

7. A renewable energy power system comprising:
a battery energy storage system having at least one rechargeable battery;
a charging and discharging converter for discharging and charging the battery energy storage system;
a power consumer;
a renewable energy resource to provide electrical power to the power consumer and/or the charging and discharging converter; and
a system controller in operative connection to control the charging and discharging converter, the system controller configured to,
forecast a power production of the renewable energy resource and a power consumption of the load for a future time period;
determine a net power between a value of the forecasted power production and a value of the forecasted power consumption; and
charge the rechargeable battery during a given time period, such that a charging power is lower than the determined net power when the determined net power is positive.

8. The renewable energy power system of claim 7, wherein the system controller is further configured to
discharge the rechargeable battery during the given time period, such that a discharging power is lower than a power that is currently consumed by the load when the determined net power is negative.

9. The renewable energy power system of claim 7, wherein in the charging, in case the value of the forecasted power production is high as compared to a maximal possible power production, and the value of the forecasted power consumption is low as compared to a maximal possible power generation, the rechargeable battery is charged at a rate that is at least 50% below a C-rate.

10. The renewable energy power system of claim 7, wherein the system controller is further configured to
normalize the predicted power production relative to a maximal power production value, and normalize the predicted power consumption relative to a maximal power consumption value,
wherein in the determining, the net power is calculated based on the normalized predicted power production and normalized power consumption values.

11. The renewable energy power system of claim 7, wherein the system controller is further configured to
classify the forecasted power production for the future time period into one of several forecast prediction categories, and classify the forecasted power consumption of the load into one of several power consumption categories.

12. The renewable energy power system of claim 10, wherein the system controller is further configured to
adjust the maximal power production value and the maximal power consumption value based on a sliding average value in time.

13. A non-transitory computer readable medium having computer instruction code recorded thereon, the computer instruction code configured to be executed on a system controller having a microprocessor to perform a method of controlling battery charging and discharging on a system having a renewable energy resource, a rechargeable battery, a battery charger for charging the rechargeable battery, and a load, the method including the steps of:
forecasting a power production of the renewable energy resource and a power consumption of the load for a future time period;
determining a net power between a value of the forecasted power production and a value of the forecasted power consumption; and
charging the rechargeable battery during a given time period, such that a charging power is lower than the determined net power when the determined net power is positive.

14. The non-transitory computer readable medium of claim 13, the method further comprising the step of:
discharging the rechargeable battery during the given time period, such that a discharging power is lower than a power that is currently consumed by the load when the determined net power is negative.

15. The non-transitory computer readable medium of claim 13, wherein the charging step, in case the value of the forecasted power production is high as compared to a maximal possible power production, and the value of the forecasted power consumption is low as compared to a maximal possible power generation, the rechargeable battery is charged at a rate that is at least 50% below a c-rate.

16. The non-transitory computer readable medium of claim 13, the method further comprising the step of:
normalizing the predicted power production relative to a maximal power production value, and normalizing the predicted power consumption relative to a maximal power consumption value, wherein in the step of determining, the net power is calculated based on the normalized predicted power production and power consumption values.

17. The non-transitory computer readable medium of claim 13, the method further comprising the step of:
classifying the forecasted power production for the future time period into one of several forecast prediction categories, and classifying the forecasted power consumption of the load into one of several power consumption categories.

18. The non-transitory computer readable medium of claim 16, the method further comprising the step of:
adjusting the maximal power production value and the maximal power consumption value based on a sliding average value in time.

19. A method for increasing a battery life of a Li-ion battery of a portable electronic device, the method performed on the portable electronic device having a battery charger for charging the Li-ion battery, the method comprising the steps of:
determining a duration of an idle time of the portable electronic device based on historic data of past idle times; and
during a next idle time, charging the Li-ion battery at a power rate that approximates a duration of the next idle time.
